(19) United States
(12) Patent Application Publication
(10) Pub. No.: US 2026/0042456 A1
(43) Pub. Date: Feb. 12, 2026

(54) DRIVING SUPPORT DEVICE, DRIVING SUPPORT METHOD, AND STORAGE MEDIUM

(71) Applicant: HONDA MOTOR CO., LTD., Tokyo (JP)

(72) Inventor: Satoshi Sadamura, Tokyo (JP)

(21) Appl. No.: 19/283,284

(22) Filed: Jul. 29, 2025

(30) Foreign Application Priority Data
Aug. 8, 2024 (JP) 2024-132786

(51) Int. Cl. B60W 50/16; B60W 30/095; B60W 40/08; B60W 50/14; G06V 20/58

(52) U.S. Cl. CPC B60W 50/16; B60W 30/0956; B60W 40/08; G06V 20/58; B60W 2050/143; B60W 2050/146; B60W 2420/403; B60W 2540/223; B60W 2554/4041; B60W 2554/4044

(57) ABSTRACT

A driving support device includes a surrounding condition recognizer configured to recognize surrounding conditions of a vehicle, a plurality of vibrators configured to provide a stimulus based on vibration to an occupant of the vehicle, and a vibration controller configured to cause at least one vibrator out of the plurality of vibrators to vibrate on the basis of a relative position of the vehicle with respect to an object recognized by the surrounding condition recognizer and a direction of the object with respect to the vehicle. At least one of the plurality of vibrators is installed at a position at which vibration is able to be provided to a sole of the occupant of the vehicle.

### CROSS-REFERENCE TO RELATED APPLICATION

Priority is claimed on Japanese Patent Application No. 2024-132786, filed Aug. 8, 2024, the content of which is incorporated herein by reference.

### BACKGROUND

### Field of the Invention

The present invention relates to a driving support device, a driving support method, and a storage medium.

### Description of Related Art

Recently, measures for providing access to a sustainable transportation system in consideration of persons in vulnerable situations out of traffic participants have been actively taken. For the purpose of realization thereof, research and development for improving safety or convenience of traffic through research and development associated with driving support technology has been focused upon. In this regard, recently, an information presentation system including an inter-vehicle information estimator configured to estimate inter-vehicle information including at least an inter-vehicle distance from another vehicle which is present in front of a vehicle in a traveling direction and a provider configured to provide a predetermined tactile stimulus to a sole of a driver of the vehicle on the basis of the inter-vehicle information is known (for example, Japanese Unexamined Patent Application, First Publication No. 2020-131892).

### SUMMARY

In such driving support technology, since there is a likelihood that an object will approach a vehicle in other directions in addition to the forward direction of the vehicle, but only an object in front of the vehicle in a traveling direction of the vehicle is handled in the related art, there is a problem in that appropriate information cannot be provided to an occupant.

The present invention was made to solve the aforementioned problem and an objective thereof is to provide a driving support device, a driving support method, and a storage medium that can provide more appropriate information to an occupant of a vehicle according to surrounding conditions of the vehicle and support driving of the vehicle. Another objective of the present invention is to contribute to development of a sustainable transportation system.

A driving support device, a driving support method, and a storage medium according to the present invention employ the following configurations.

(1) A vehicle control device according to an aspect of the present invention is a driving support device including a surrounding condition recognizer configured to recognize surrounding conditions of a vehicle, a plurality of vibrators configured to provide a stimulus based on vibration to an occupant of the vehicle, and a vibration controller configured to cause at least one vibrator out of the plurality of vibrators to vibrate on the basis of a relative position of the vehicle with respect to an object recognized by the surrounding condition recognizer and a direction of the object with respect to the vehicle, wherein at least one of the plurality of vibrators is installed at a position at which vibration is able to be provided to a sole of the occupant of the vehicle.

(2) In the aspect of (1), the vibration controller determines a vibration mode in the plurality of vibrators according to the relative position and the direction of the object.

(3) In the aspect of (1), the driving support device further includes a tiptoe detector configured to detect a position of a tiptoe of the occupant, and the vibration controller determines a vibration mode in the plurality of vibrators according to the position of the tiptoe detected by the tiptoe detector.

(4) In the aspect of (3), the driving support device further includes a notifier configured to notify the occupant of information using at least one of display and sound, the occupant includes a driver of the vehicle, the tiptoe detector detects a shoe of the driver, and the driving support device further includes a notification controller configured to notify the driver via the notifier when the shoe of the driver is a shoe which is not suitable for driving.

(5) In the aspect of (1), the driving support device further includes a motion recognizer configured to recognize a predetermined motion of the occupant's foot, and the vibration controller controls starting or stopping of vibration control of the vibrators according to a predetermined tapping motion or a predetermined gesture motion of the occupant's foot recognized by the motion recognizer.

(6) In the aspect of (4), the notification controller performs notification of the occupant via the notifier on the basis of a degree of risk of contact or closeness between the vehicle and the object, and a notification timing in the notification controller and a vibration timing in the vibration controller are controlled synchronously or stepwise under predetermined conditions.

(7) In the aspect of (1), at least one of the plurality of vibrators is installed in a pedal operator of the vehicle, and the vibration controller performs vibration control on the vibrator installed in the pedal operator when a driving mode of the vehicle is a manual driving mode or when the driving mode is switched from an automated driving mode to the manual driving mode.

(8) In the aspect of (1), at least one of the plurality of vibrators is installed in a pedal operator of the vehicle, and the vibration controller performs vibration control on the vibrator installed in the pedal operator when a foot of a driver of the vehicle comes into contact with the pedal operator.

(9) A vehicle control method according to another aspect of the present invention is a driving support method that is performed by a computer, the driving support method including recognizing surrounding conditions of a vehicle and causing at least one vibrator out of a plurality of vibrators, which are configured to provide a stimulus based on vibration to an occupant of the vehicle, to vibrate on the basis of a relative position of the vehicle with respect to an object included in the recognized surrounding conditions and a direction of the object with respect to the vehicle, wherein at least one of the plurality of vibrators is installed at a position at which vibration is able to be provided to a sole of the occupant of the vehicle.

(10) A storage medium according to another aspect of the present invention is a non-transitory computer-readable storage medium for storing a program causing a computer to perform recognizing surrounding conditions of a vehicle and causing at least one vibrator out of a plurality of vibrators, which are configured to provide a stimulus based on vibration to an occupant of the vehicle, to vibrate on the basis of a relative position of the vehicle with respect to an object included in the recognized surrounding conditions and a direction of the object with respect to the vehicle, wherein at least one of the plurality of vibrators is installed at a position at which vibration is able to be provided to a sole of the occupant of the vehicle.

According to the aspects of (1) to (10), it is possible to provide more appropriate information to an occupant of a vehicle according to surrounding conditions of the vehicle and to support driving of the vehicle.

### BRIEF DESCRIPTION OF THE DRAWINGS

FIG. 1 is a diagram illustrating a configuration of a vehicle in which a driving support device according to an embodiment is mounted.

FIG. 2 is a diagram illustrating an example of first vibration control.

FIG. 3 is a diagram illustrating an example of second vibration control.

FIG. 4 is a diagram illustrating a specific example of a vibration mode in the second vibration control.

FIG. 5 is a diagram illustrating an example of third vibration control.

FIG. 6 is a diagram illustrating a detected position of a tiptoe.

FIG. 7 is a diagram illustrating an example of fourth vibration control.

FIG. 8 is a diagram illustrating an example of fifth vibration control.

FIG. 9 is a diagram illustrating an example of sixth vibration control.

FIG. 10 is a diagram illustrating an example of seventh vibration control.

FIG. 11 is a diagram illustrating a first installation example of vibrators.

FIG. 12 is a diagram illustrating a second installation example of vibrators.

FIG. 13 is a diagram illustrating an example of detection of a shoe.

FIG. 14 is a diagram illustrating recognition of a motion of an occupant's foot using a motion recognizer.

FIG. 15 is a flowchart illustrating an example of a process flow that is performed by the driving support device according to the embodiment.

### DESCRIPTION OF EMBODIMENTS

Hereinafter, a driving support device, a driving support method, and a storage medium according to an embodiment of the present invention will be described with reference to the accompanying drawings.

### [Entire Configuration]

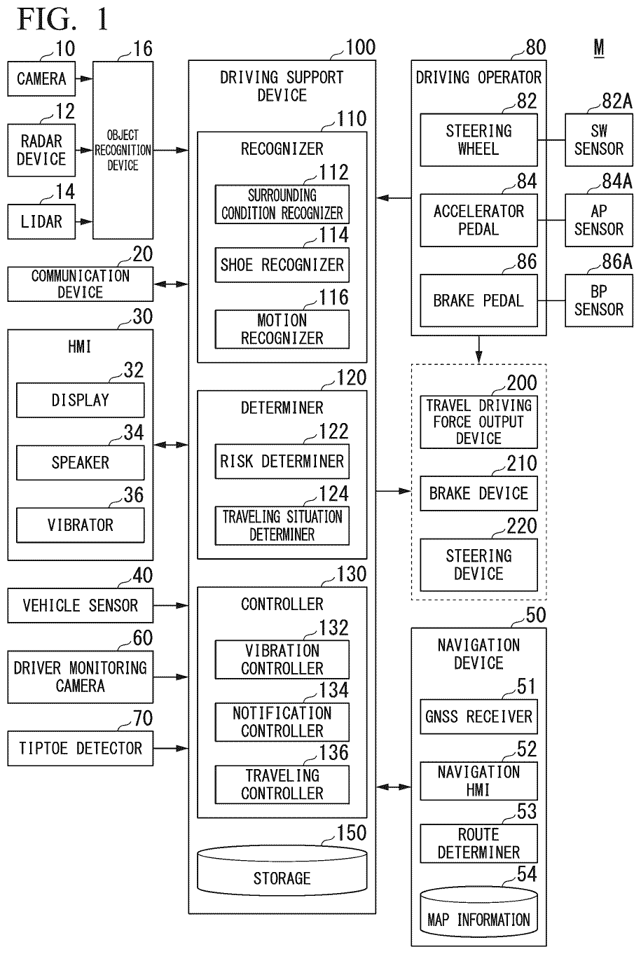

FIG. 1 is a diagram illustrating a configuration of a vehicle M in which a driving support device according to an embodiment is mounted. The vehicle M is, for example, a vehicle with two wheels, three wheels, or four wheels, and a drive source thereof is an internal combustion engine such as a diesel engine or a gasoline engine, an electric motor, or a combination thereof. The electric motor operates using electric power generated by a power generator connected to the internal combustion engine or using electric power discharged from a secondary battery or a fuel cell.

For example, a camera 10, a radar device 12, a Light Detection and Ranging (LIDAR) device 14, an object recognition device 16, a communication device 20, a human-machine interface (HMI) 30, a vehicle sensor 40, a navigation device 50, a driver monitoring camera 60, a tiptoe detector 70, a driving operator 80, a driving support device 100, a travel driving force output device 200, a brake device 210, and a steering device 220 are mounted in the vehicle M. These devices or instruments are connected to each other via a multiplex communication line such as a controller area network (CAN) communication line, a serial communication line, a radio communication network, or the like. The configuration illustrated in FIG. 1 is only an example, and a part of the configuration may be omitted or another configuration may be added thereto. The HMI 30 is an example of a “notifier.”

The camera 10 is, for example, a digital camera using a solid-state imaging device such as a charge coupled device (CCD) or a complementary metal oxide semiconductor (CMOS). The camera 10 is attached to an arbitrary position on the vehicle M. When a forward view is imaged, the camera 10 is attached to an upper part of a front windshield, a rear surface of a rearview mirror, or the like. The camera 10 images the surroundings of the vehicle M, for example, periodically and repeatedly. The camera 10 may be a stereo camera.

The radar device 12 radiates radio waves such as millimeter waves to the surroundings of the vehicle M, detects radio waves (reflected waves) reflected by an object, and detects at least a position (a distance and a direction) of the object. The radar device 12 is attached to an arbitrary position on the vehicle M. The radar device 12 may detect a position and a speed of an object using a frequency modulated continuous wave (FM-CW) method.

The LIDAR device 14 radiates light (or electromagnetic waves of wavelengths close to light) to the surroundings of the vehicle M and measures scattered light. The LIDAR device 14 detects a distance to an object on the basis of a period of time from radiation of light to reception of the light. The radiated light is, for example, a pulse-like laser beam. The LIDAR device 14 is attached to an arbitrary position on the vehicle M.

The object recognition device 16 performs a sensor fusion process on results of detection from some or all of the camera 10, the radar device 12, and the LIDAR device 14 and recognizes a position, a type, a speed, and the like of an object. The object recognition device 16 outputs the result of recognition to the driving support device 100.

The object recognition device 16 may output the results of detection from the camera 10, the radar device 12, and the LIDAR device 14 to the driving support device 100 without any change. The object recognition device 16 may be omitted from the host vehicle M. Some or all of the camera 10, the radar device 12, the LIDAR device 14, and the object recognition device 16 are an example of an “outside sensing device.”

The communication device 20 communicates with other vehicles near the vehicle M, for example, using a cellular network, a Wi-Fi network, Bluetooth (registered trademark), or dedicated short range communication (DSRC) or communicates with various server devices via radio base stations.

The HMI 30 presents various types of information to an occupant of the vehicle M and receives an input operation from the occupant. The HMI 30 includes, for example, a display 32, a speaker 34, and a vibrator 36. The display 32 is, for example, a liquid crystal display (LCD) device or an organic electroluminescence (EL) display device. The display 32 displays various images (including a video) according to the embodiment. The display 32 may be configured as a touch panel which is a unified body with an input. The speaker 34 outputs predetermined sound (for example, an alarm).

For example, the vibrator 36 provides a stimulus based on vibration to an occupant on the basis of an instruction from the driving support device 100. The vibrator 36 includes a plurality of vibrators and is installed, for example, at a position at which vibration is able to be applied to a seat or a sole of an occupant. The position at which vibration is able to be applied to a sole of an occupant includes, for example, a cabin floor (a floor), a pedal operator (an accelerator pedal or a brake pedal), and a footrest. The vibrator 36 may be installed a steering wheel 82 included in the driving operator 80, a seat belt under used, or the like. The vibrators 36 may be arranged at predetermined intervals.

For example, a linear resonant actuator (LRA) which is a kind of voice coil motor is used as the vibrator 36, but a means (an actuator) thereof is not limited to this example as long as it can deliver a tactile stimulus based on vibration to a driver. Accordingly, an eccentric motor, a linear motor, a vibration speaker, or the like may be used as the vibrator 36.

The HMI 30 may include a microphone, buzzers, a touch panel, and keys in addition to the display 32, the speaker 34, and the vibrator 36. For example, the HMI 30 may include a switch for switching a driving state (details of driving control) of the vehicle M according to an operation of a driver of the vehicle M.

The vehicle sensor 40 includes a vehicle speed sensor that detects a speed of the vehicle M, an acceleration sensor that detects acceleration, a yaw rate sensor that detects a yaw rate (for example, an angular velocity around a vertical axis passing through the center of gravity of the vehicle M), a lateral acceleration sensor (a lateral G sensor) that detects lateral acceleration (lateral G) of the vehicle M, a direction sensor that detects a direction of the vehicle M, and a steering angle sensor that detects a steering angle (which may be an angle of turning wheels or may be an operation angle of a steering wheel) of the vehicle M. The vehicle sensor 40 may include a position sensor that detects a position of the vehicle M. The position sensor is, for example, a sensor that acquires position information (longitude and latitude information) from a global positioning system (GPS) device. The position sensor may be a sensor that acquires position information using a global navigation satellite system (GNSS) receiver 51 of the navigation device 50. The vehicle sensor 40 may include a vibration sensor that detects vibration acquired from a traveling road on which the vehicle M is traveling.

The navigation device 50 includes, for example, a GNSS receiver 51, a navigation HMI 52, and a route determiner 53. The navigation device 50 stores map information 54 in a storage device such as a hard disk drive (HDD) or a flash memory. The GNSS receiver 51 identifies a position of the vehicle M on the basis of signals received from GNSS satellites. The position of the vehicle M may be identified or corrected by an inertial navigation system (INS) using the output of the vehicle sensor 40. The navigation HMI 52 includes a display device, a speaker, a touch panel, and keys. The navigation HMI 52 may be partially or wholly shared by the HMI 30. For example, the route determiner 53 determines a route (hereinafter referred to as a route on a map) from the position of the vehicle M identified by the GNSS receiver 51 (or an input arbitrary position) to a destination input by an occupant using the navigation HMI 52 with reference to the map information 54. The map information 54 is, for example, information in which a road shape is expressed by links indicating a road and nodes connected by the links. The map information 54 may include point of interest (POI) information. The map information 54 may include, for example, information of a lane center or lane boundary information such as a road marking line (hereinafter referred to as marking line) defining a lane. The map information 54 may include road information such as a radius of curvature (or a curvature), a gradient, and a width of a road (or for each lane included in the road), traffic regulation information, address information (addresses and postal codes), facility information, and phone number information. The map information 54 may be updated from time to time by causing the communication device 20 to communicate with another device. The map information 54 may be stored in a storage of the driving support device 100.

The navigation device 50 may perform route guidance using the navigation HMI 52 on the basis of the route on a map. The navigation device 50 may be realized, for example, by a function of a terminal device such as a smartphone or a tablet terminal which is carried by an occupant. The navigation device 50 may transmit a current position and a destination to a navigation server via the communication device 20 and acquire a route which is equivalent to the route on a map from the navigation server.

The driver monitoring camera 60 is, for example, a digital camera using a solid-state imaging device such as a CCD or a CMOS. The driver monitoring camera 60 is attached to an arbitrary position on the vehicle M at which the inside of a cabin including a driver sitting on a driver's seat of the vehicle M can be imaged. On the basis of a camera image captured by the driver monitoring camera 60, a direction of a face or a position of a hand of a driver can be acquired and a position of a seat on which an occupant other than the driver is sitting can also be acquired. The driver monitoring camera 60 outputs the captured image to the driving support device 100.

The tiptoe detector 70 detects, for example, a position of a tiptoe (for example, a front part from an ankle or a heel) of an occupant. A specific example of the tiptoe detector 70 will be described later.

The driving operator 80 includes, for example, a steering wheel 82, an accelerator pedal 84, a brake pedal 86, an operation switch of a direction indicator, a shift lever, and other operators. A sensor that detects an amount of operation or whether an operation has been performed is attached to the driving operator 80. Results of detection of the sensor are output to the driving support device 100 or output to some or all of the travel driving force output device 200, the brake device 210, and the steering device 220. The steering wheel 82 is an example of a “steering operator.” The accelerator pedal 84 and the brake pedal 86 are examples of a “pedal operator.”

For example, a steering wheel sensor (SW sensor) 82A or the vibrator 36 that vibrates a part grasped by a driver is provided in the steering wheel 82. The SW sensor 82A detects whether a driver is in contact with the steering wheel 82. The SW sensor 82A detects an amount of operation (a torque which may also be referred to as a steering torque, an amount of steering, or a rate of change of steering) of the steering wheel 82 which varies according to a driver's operation of the steering wheel 82 (hereinafter referred to as a steering operation). The SW sensor 82A may detect whether a driver is grasping the steering wheel 82. The steering wheel 82 does not have to have a ring shape and may have a shape of a deformed steering wheel, a joystick, a button, or the like. In this case, the SW sensor 82A detects an amount of operation corresponding to each shape.

An accelerator pedal sensor (AP sensor) 84A is provided in the accelerator pedal 84. The AP sensor 84A detects whether a driver's foot is placed on the accelerator pedal 84, ON/OFF of a driver's operation on the accelerator pedal 84 (hereinafter referred to as an accelerator operation), and an amount of operation (a change in opening level or a rate of change in opening level) of the accelerator pedal 84 which varies according to the operation.

A brake pedal sensor (BP sensor) 86A is provided in the brake pedal 86. The BP sensor 86A detects whether a driver's foot is placed on the brake pedal 86, ON/OFF of a driver's operation on the brake pedal 86 (hereinafter referred to as a brake operation), and an amount of operation (a change in opening level or a rate of change in opening level) of the brake pedal 86 which varies according to the operation. The accelerator operation and the brake operation are examples of “speed adjustment.”

The travel driving force output device 200 outputs a travel driving force (a torque) for allowing the vehicle M to travel to driving wheels. The travel driving force output device 200 includes, for example, a combination of an internal combustion engine, an electric motor, and a transmission and an electronic control unit (ECU) that controls them. The ECU controls the aforementioned constituents on the basis of information input from the driving support device 100 or information input from the driving operator 80.

The brake device 210 includes, for example, a brake caliper, a cylinder that transmits a hydraulic pressure to the brake caliper, an electric motor that generates a hydraulic pressure in the cylinder, and an ECU. The ECU controls the electric motor on the basis of the information input from the driving support device 100 or the information input from the driving operator 80 such that a brake torque based on a braking operation is output to vehicle wheels. The brake device 210 may include a mechanism for transmitting a hydraulic pressure generated by an operation of the brake pedal 86 included in the driving operator 80 to the cylinder via a master cylinder as a backup. The brake device 210 is not limited to the above-mentioned configuration and may be an electronically controlled hydraulic brake device that controls an actuator on the basis of information input from the driving support device 100 such that the hydraulic pressure of the master cylinder is transmitted to the cylinder.

The steering device 220 includes, for example, a steering ECU and an electric motor. The electric motor changes a direction of turning wheels, for example, by applying a force to a rack-and-pinion mechanism. The steering ECU drives the electric motor on the basis of the information input from the driving support device 100 or the information input from the driving operator 80 and changes the direction of the turning wheels.

### [Driving Support Device]

The driving support device 100 includes, for example, a recognizer 110, a determiner 120, a controller 130, and a storage 150. The recognizer 110, the determiner 120, and the controller 130 are realized, for example, by causing a hardware processor such as a central processing unit (CPU) to execute a program (software). Some or all of these constituents may be realized by hardware (a circuit part including circuitry) such as a large scale integration (LSI) device, an application-specific integrated circuit (ASIC), a field-programmable gate array (FPGA), a graphics processing unit (GPU), or a system on chip (SOC) or may be cooperatively realized by software and hardware. The program may be stored in a storage device (a storage device including a non-transitory storage medium) such as an HDD or a flash memory of the driving support device 100 in advance or may be stored in a removable storage medium such as a DVD or a CD-ROM and installed in the HDD or the flash memory of the driving support device 100 by setting the removable storage medium (a non-transitory storage medium) into a drive device.

For example, settings are set in the travel driving force output device 200, the brake device 210, and the steering device 220 such that instructions for the travel driving force output device 200, the brake device 210, and the steering device 220 from the driving support device 100 are executed prior to the results of detection from the driving operator 80. Regarding brake, when a braking force based on an amount of operation on the brake pedal 86 is larger than an instruction from the driving support device 100, settings may be set such that braking with the braking force is preferentially executed. Communication priority in an onboard local area network (LAN) may be used as a means for preferentially executing an instruction from the driving support device 100.

The storage 150 may be realized by the aforementioned various storage devices, a solid-state drive (SSD), an electrically erasable programmable read only memory (EEPROM), a read only memory (ROM), a random access memory (RAM), or the like. For example, programs and various types of other information are stored in the storage 150. The aforementioned map information 54 may be stored in the storage 150.

The recognizer 110 includes, for example, a surrounding condition recognizer 112, a shoe recognizer 114, and a motion recognizer 116. The surrounding condition recognizer 112 recognizes surrounding conditions of the vehicle M on the basis of information input from an outside sensing device. For example, the surrounding condition recognizer 112 recognizes states such as a position, a speed, and an acceleration of an object near the vehicle M (for example, within a predetermined distance (a first predetermined distance) from the vehicle M). Examples of the object include a traffic participant such as another vehicle, a bicycle, and a pedestrian or a road structure such as a curbstone, a median strip, or a guard rail. For example, a position of an object is recognized as a position in an absolute coordinate system with a representative point (such as the center of gravity or the center of a drive shaft) of the vehicle M as an origin and is used for control. A position of an object may be expressed as a representative point such as the center of gravity or a corner of the object or may be expressed as an area. A “state” of an object may include an acceleration or a jerk of the object or a “moving state” (for example, whether lane change is being performed or whether lane change is going to be performed) thereof when the object is a mobile object. The surrounding condition recognizer 112 recognizes a relative position or a relative speed of an object.

The surrounding condition recognizer 112 recognizes, for example, a lane (a traveling lane) in which the vehicle M is traveling. For example, the surrounding condition recognizer 112 performs known analysis processing (for example, edge extraction, feature extraction, or a pattern matching process) on an image (a camera image) captured by the camera 10 and recognizes a position or a pattern of a marking line (for example, arrangement of a solid line and a dotted line) near the vehicle M from the analysis result. The marking line is also an example of an object. The surrounding condition recognizer 112 may recognize a position or a pattern of a marking line near the vehicle M with reference to the map information 54 on the basis of the position information of the vehicle M. The surrounding condition recognizer 112 may recognize the traveling lane using at least one of a position or a pattern of a marking line acquired from the camera image and a position or a pattern of a marking line acquired from the map information. The surrounding condition recognizer 112 is not limited to the marking lines, but may recognize the traveling lane by recognizing traveling lane boundaries (road boundaries) including edges of roadsides, curbstones, median strips, and guard rails. In this recognition, the position of the vehicle M acquired from the navigation device 50 or the result of processing from the INS may be considered. The surrounding condition recognizer 112 may recognize a neighboring lane adjacent to the traveling lane. The surrounding condition recognizer 112 may recognize a radius of curvature (or a curvature), a gradient, a width, and the like of a traveling lane (or a road) from at least one of the camera image and the map information. The surrounding condition recognizer 112 recognizes an obstacle, a stop line, a red signal, a toll gate, or other road events from recognition results of the surrounding conditions. The obstacle includes an object which hinders traveling in the traveling lane or an object which the vehicle M needs to avoid collision with (such as traffic participants). These objects are included in the object.

The surrounding condition recognizer 112 may recognize a position or a posture of the vehicle M with respect to the traveling lane. The surrounding condition recognizer 112 may recognize, for example, a degree of separation of a reference point of the vehicle M from the lane center and an angle of the traveling direction of the vehicle M with respect to a line formed by connecting the lane centers as the relative position and the posture of the vehicle M with respect to the traveling lane. Instead, the surrounding condition recognizer 112 may recognize a position of a reference point of the vehicle M with respect to one side line of the traveling lane (a road marking line or a road boundary) or the like as the relative position of the vehicle M with respect to the traveling lane. The surrounding condition recognizer 112 may recognize a position or a posture of another vehicle traveling in the traveling lane of the vehicle M or recognize whether another vehicle is located on the center side or the marking line side of the traveling lane when seen from the vehicle M.

The shoe recognizer 114 recognizes a shoe worn by a driver of the vehicle M. For example, the shoe recognizer 114 recognizes a type of a shoe of the driver on the basis of the result of detection from the tiptoe detector 70. Details of a function that is performed by the shoe recognizer 114 will be described later.

The motion recognizer 116 recognizes a motion (for example, a tapping motion or a gesture motion) of an occupant's foot on the basis of the result of detection from the tiptoe detector 70. Details of a function that is performed by the motion recognizer 116 will be described later.

The determiner 120 includes, for example, a risk determiner 122 and a traveling situation determiner 124. The risk determiner 122 determines there is a risk (a likelihood) that the vehicle M will come into contact with an object near the vehicle M on the basis of the result of recognition from the surrounding condition recognizer 112. When it is determined that there is a risk, the risk determiner 122 determines which direction (for example, a forward direction, a rearward direction, a rightward direction, or a leftward direction) with respect to the vehicle M the direction in which there is a risk is.

For example, the risk determiner 122 calculates a first time to collision (TTC) until the vehicle M comes into contact with an object on the basis of a relative distance and a relative speed of the object with respect to the vehicle M. The first time to collision TTC is calculated, for example, by dividing the relative distance by the relative speed. The risk determiner 122 determines that there is a risk of contact between the vehicle M and the object when the calculated first time to collision TTC is less than a predetermined time and determines that there is no risk of contact when the first time to collision TTC is greater than the predetermined time. The risk determiner 122 may determine whether there is a risk that the vehicle M and the object will get close within a predetermined distance without using the risk of contact between the vehicle M and the object. In this case, the determination may be performed by setting the predetermined time to a value greater than the time in which the determination of contact is performed, or the determination may be performed on the basis of a distance from a target object (a relative distance). Accordingly, since a driver of the vehicle M can be notified that there is an object near the vehicle (that is, there is an object approaching the vehicle) as well as that there is a likelihood of contact, it is possible to further improve preventive safety. When it is determined that there is a likelihood of contact or closeness between the vehicle M and an object, the risk determiner 122 may determine a magnitude of the degree of risk. In this case, the degree of risk increases as the first time to collision TTC (or the relative distance) decreases.

The traveling situation determiner 124 determines a traveling situation of the vehicle M on the basis of the result of recognition from the surrounding condition recognizer 112. For example, the traveling situation determiner 124 determines whether there is a likelihood of departure of the vehicle M from a marking line defining the traveling lane on the basis of the result of recognition. For example, the traveling situation determiner 124 determines that there is a likelihood of departure of the vehicle M from the traveling lane when there is a likelihood that a reference position (for example, an end, the center, or the center of gravity) of the vehicle M will go over (pass over) one marking line of left and right marking lines defining the traveling lane recognized by the recognizer 110 and depart from the traveling lane and determines that there is no likelihood of departure of the vehicle M from the traveling lane when there is no likelihood that the reference line will depart from the traveling lane.

The traveling situation determiner 124 derives a future predicted route of the vehicle M from the speed and the yaw rate of the vehicle M acquired from the vehicle sensor 40 and calculates a second time to line crossing TTLC(=d/VM) until the vehicle M reaches the marking line on the basis of a distance (a departure path length d) between the derived predicted path and the marking line and the speed VM. Then, the traveling situation determiner 124 determines that there is a likelihood that the vehicle M will depart from the traveling lane when the second time to line crossing TTLC is less than a predetermined time and determines that there is no likelihood of departure when the second time to line crossing TTLC is equal to or greater than the predetermined time. When it is determined that there is a likelihood that the vehicle M will depart from the traveling lane, the traveling situation determiner 124 may determine a magnitude of the likelihood of departure. In this case, the magnitude of the likelihood of departure increases as the second time to line crossing TTLC decreases.

In addition to the aforementioned function, the determiner 120 may determine whether a shoe recognized by the shoe recognizer 114 is a shoe which is appropriate for driving or determine whether a motion of an occupant's foot is a predetermined motion on the basis of the result of recognition from the motion recognizer 116.

The controller 130 controls various functions, devices, or the like of the vehicle M. The controller 130 includes, for example, a vibration controller 132, a notification controller 134, and a traveling controller 136. The vibration controller 132 performs control for causing at least one of the plurality of vibrators 36 to vibrate, for example, on the basis of the result of determination from the risk determiner 122, the result of determination from the traveling situation determiner 124, or the like. In this case, for example, the vibration controller 132 determines a vibration mode in the plurality of vibrators according to a relative position to an object or a direction of the object. A vibration mode includes, for example, at least one of a position of a vibrator to vibrate, a magnitude of vibration (a vibration intensity), and a vibration period (for example, including a frequency or a pattern). The vibration controller 132 may control vibration of the vibrators 36 on the basis of the result of recognition from the shoe recognizer 114 or the result of recognition from the motion recognizer 116.

The notification controller 134 notifies an occupant of the vehicle M of predetermined information, for example, on the basis of information acquired from the communication device 20, the HMI 30, the vehicle sensor 40, the driver monitoring camera 60, or the like, information detected by the SW sensor 82A, the AP sensor 84A, or the BP sensor 86A, the results of recognition from the recognizer 110, the results of determination from the determiner 120, and the like. The predetermined information includes, for example, information associated with traveling of the vehicle M such as information on the state of the vehicle M or information on driving control. The information on the state of the vehicle M includes, for example, a speed, an engine rotation speed, and a shift position of the vehicle M. The information on driving control includes, for example, a type of driving control under execution (for example, a driving state), an operating reason of driving control, an operating reason of vibration control, a situation of driving control, and information indicating that driving control has started or ended. The information on driving control may include information on an alarm to a driver (for example, a departure alarm), a predetermined driving operation, or attention attraction. The predetermined information may include information on a current position or a destination of the vehicle M and a residual amount of fuel or may include information not associated with traveling control of the vehicle M such as television programs and content (for example, movies) stored in a storage medium such as DVD.

For example, the notification controller 134 may generate an image including the predetermined information and display the generated image on the display 32 of the HMI 30 or may generate sound indicating the predetermined information and output the generated sound from the speaker 34 of the HMI 30. The timing at which sound is output is, for example, a timing at which driving control starts or stops, a timing of an incoming call, a timing at which a displayed image is switched, and a timing at which the vehicle M enters a predetermined state. The notification controller 134 may perform control such that notification to an occupant is performed in synchronization with vibration control of the vibration controller 132 or stepwise with vibration control.

The traveling controller 136 performs driving control for controlling at least one of the speed and the steering of the vehicle M on the basis of the results of recognition from the recognizer 110. For example, when the traveling situation determiner 124 determines that there is a likelihood that the vehicle M will depart from the traveling lane, the traveling controller 136 controls at least the steering device 220 such that the vehicle M does not depart from the traveling lane. When the risk determiner 122 determines that there is a likelihood that the vehicle M and an object will come into contact, the traveling controller 136 controls at least one of the brake device 210, the travel driving force output device 200, and the steering device 220 and performs driving control such that contact between the vehicle M and the object is avoided.

The traveling controller 136 may perform driving control such as adaptive cruise control system (ACC) control for causing the vehicle M to travel at a preset speed (a set speed) in the traveling lane or auto lane change (ALC) control for operating at least steering of the vehicle M to change the traveling lane of the vehicle M on the basis of the results of recognition from the surrounding condition recognizer 112, an instruction of a driver from the HMI 30, or the like. The aforementioned driving control includes completely automated driving. In this case, driving control for controlling the speed and the steering of the vehicle M regardless of a driver's operation is performed.

### [Vibration Control]

Details of vibration control which is performed by the vibration controller 132 will be described below in some examples. In the following description, vibration control for a driver sitting on a driver's seat will be mainly described, but the same vibration control may be performed for an occupant other than the driver sitting on another seat of the vehicle M. At what position an occupant is sitting can be acquired, for example, by performing a known person recognizing process on a camera image captured by the driver monitoring camera 60.

### <First Vibration Control>

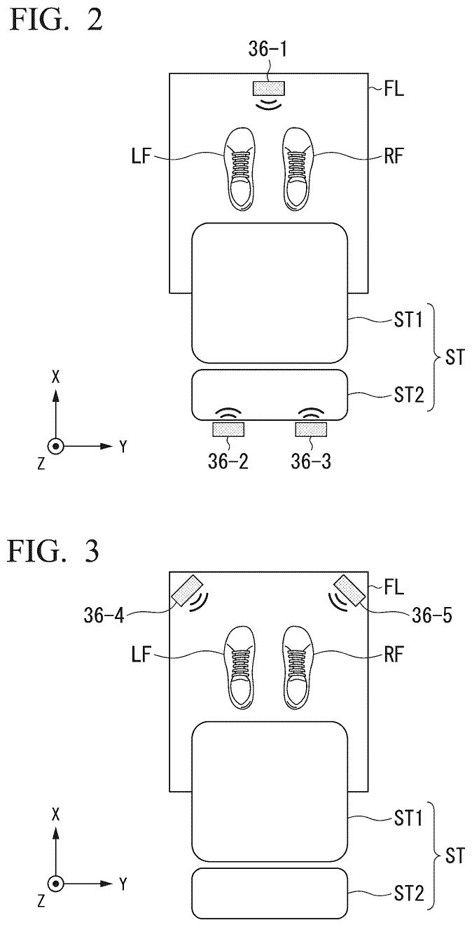

FIG. 2 is a diagram illustrating an example of first vibration control. In the example illustrated in FIG. 2, a schematic diagram of the vicinity of a driver's seat when seen from above is illustrated. In FIG. 2, an X-axis direction indicates a longitudinal direction of the vehicle M, and a Y-axis direction indicates a lateral direction of the vehicle M. In the example illustrated in FIG. 2, the floor (the bottom) FL (an example of an area in which vibration can be provided to a sole of a driver), a seat ST on which the driver sits, and positions of a left foot LF and a right foot RF of the driver placed on the floor FL are schematically illustrated. The seat ST includes a sitting seat portion ST1 and a back seat portion ST2. In the example illustrated in FIG. 2, a vibrator 36-1 is installed at the center in the front of the floor FL, and vibrators 36-2 and 36-3 are installed on the left and right sides of the back seat portion ST2. For example, when driving control for controlling the speed of the vehicle M regardless of an operation of an occupant of the vehicle M is performed, both feet of the driver may be placed on the floor FL as illustrated in FIG. 2.

In the configuration illustrated in FIG. 2, for example, when the risk determiner 122 determines that there is a risk of contact with an object in front of the vehicle M, the vibration controller 132 causes the vibrator 36-1 to vibrate. Accordingly, vibration from the vibrator 36-1 is transmitted to the soles of the left foot LF and the right foot RF of the driver placed on the floor FL. The driver is provided with a stimulus based on vibration from the soles (particularly, the tiptoes) and thus can ascertain that a risk has occurred in front of the vehicle M. In the first vibration control, when the risk determiner 122 determines that there is a risk of contact with an object at the back of the vehicle M, the vibration controller 132 causes the vibrators 36-2 and 36-3 to vibrate. Accordingly, the driver feels vibration from the back in contact with the back seat portion ST2 and thus can ascertain that a risk has occurred at the back. As a result, it is possible to more accurately notify the occupant of the surrounding conditions. The vibration controller 132 may cause only the vibrator 36-2 to vibrate when it is determined that there is a risk on the left-back side of the vehicle M and cause only the vibrator 36-3 to vibrate when it is determined that there is a risk on the right-back side. Accordingly, it is possible to more accurately allow the driver to ascertain on which of the left and right sides at the back there is a risk.

The vibration controller 132 may change a vibration mode such as a magnitude of vibration or a vibration period according to the degree of risk determined by the risk determiner 122. In this case, for example, the vibration controller 132 increases the magnitude of vibration or shortens the vibration period as the degree of risk increases. The vibration controller 132 may change the vibration mode according to a direction in which there is a risk. In this case, for example, the vibration controller 132 increases the magnitude of vibration or shortens the vibration period as the direction in which there is a risk becomes closer to the traveling direction of the vehicle M. In this way, by changing the vibration mode according to the surrounding conditions, it is possible to allow the driver to intuitively ascertain a risk. For example, it is also possible to allow the driver to intuitively ascertain a direction in which there is a risk of coming closer to the vehicle or an event in which a risk is moving away from the vehicle.

In the first vibration control, the vibration controller 132 performs control for causing a vibrator close to a departure side to vibrate even when the traveling situation determiner 124 determines that the vehicle M will depart from the traveling lane (the marking line) instead of (in addition to) the results of determination from the risk determiner 122. The vibration controller 132 may change the vibration mode of the vibrators 36 according to the magnitude of likelihood of departure. Accordingly, it is possible to allow the driver to more appropriately ascertain the traveling situation.

### <Second Vibration Control>

FIG. 3 is a diagram illustrating an example of second vibration control. The example illustrated in FIG. 3 is different from the example illustrated in FIG. 2, in that vibrators 36-4 an 36-5 are installed on the left and right sides in the front of the floor FL instead of the center in the front of the floor FL and no vibrator 36 is provided in the back seat portion ST2. In the second vibration control, the vibration controller 132 controls the vibration modes of the vibrators 36-4 and 36-5 according to a direction in which there is a risk determined by the risk determiner 122.

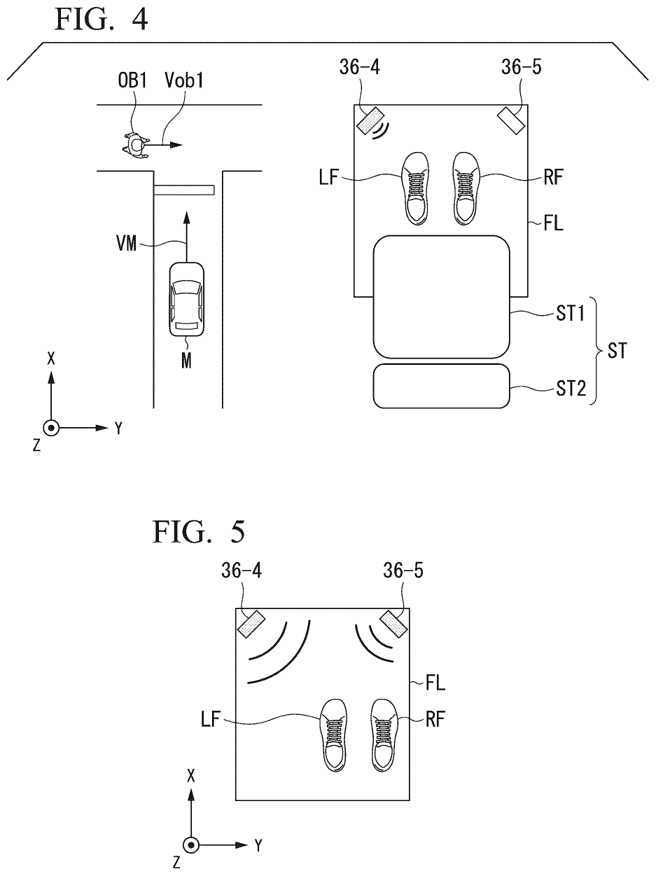

FIG. 4 is a diagram illustrating a specific example of the vibration mode in the second vibration control. In the example illustrated in FIG. 4, it is assumed that the vehicle M is traveling to a T junction and a pedestrian OB1 (an example of an object) approaches the vehicle M from the left side of the vehicle M in the T junction. Here, it is assumed that the vehicle M is traveling at a speed VM and the pedestrian OB1 is moving at a speed Vob1.

In this case, the risk determiner 122 determines whether there is a risk (a likelihood) of contact between the vehicle M and the pedestrian OB1 on the basis of a relative position and a relative speed (speed VM-speed Vob1) of the vehicle M with respect to the pedestrian OB1. When it is determined that there is a risk of contact, the vibration controller 132 causes only the vibrator 36-4 close to the side on which the pedestrian OB1 is present when seen from the vehicle M to vibrate. Accordingly, when two feet of the driver are placed in the vicinity of the center of the floor FL, the left foot LF feels stronger vibration, and thus the driver can more accurately ascertain that an object (an obstacle) is becoming closer from the left-front side (that a risk has occurred on the left-front side). The vibration controller 132 may cause both of the vibrator 36-4 and the vibrator 36-5 to vibrate instead of causing only the vibrator 36-4 to vibrate. In this case, the vibration controller 132 controls the vibration mode such that vibration of the vibrator 36-4 in the direction in which a risk has occurred becomes larger than vibration of the other vibrator 36-5 (and/or such that the vibration period thereof is shortened). Accordingly, similarly to the first vibration control, it is possible to allow the driver to more accurately ascertain presence of a risk or the direction in which the risk is present.

In the second vibration control, the vibration controller 132 may also perform control for causing the vibrator closer to a departure side to vibrate when it is determined that the vehicle M will depart from the traveling lane instead of (in addition to) the results of determination from the risk determiner 122. The vibration controller 132 may change the vibration mode of the vibrators 36 according to the degree of risk or the magnitude of likelihood of departure. Accordingly, it is possible to allow the driver to more accurately ascertain the traveling situation.

### <Third Vibration Control>

FIG. 5 is a diagram illustrating an example of third vibration control. The vehicle M according to the embodiment can perform automated driving as well as manual driving. Accordingly, a position of a driver's tiptoe may be located nearer the front (on the front side), nearer the rear (on the rear side), nearer the left side (on the left side), or nearer the right side (on the right side) with respect to the central position of the floor FL, the tiptoes of the left and right feet may be offset to the left, right, front, or rear side, or only one foot may be placed on the floor due to crossing of the legs. As a result, in the third vibration control, the vibration modes of a plurality of vibrators 36 are controlled according to the foot positions on the floor FL.

In the example illustrated in FIG. 5, similarly to FIG. 4, vibrators 36-4 and 36-5 are installed on the left and right sides of the front of the floor FL. In the example illustrated in FIG. 5, the seat ST is not illustrated. In the example illustrated in FIG. 5, positions of the driver's feet are located on the lower right (the right-rear side) in the drawing with respect to the center of the floor FL. In this situation, when the risk determiner 122 determines that there is a risk of contact with an object and/or when the traveling situation determiner 124 determines that there is a likelihood of the vehicle M will depart from the traveling lane (the marking line), the vibrator 36-4 located at a position farther from the feet (the left foot LF and the right foot RF) out of the vibrators 36-4 and 36-5 is caused to vibrate more strongly than the vibrator 36-5. Accordingly, it is possible to reliably transmit vibration to both feet.

The vibration controller 132 may change the magnitude of vibration or the vibration period according to a distance from the feet (the left foot LF and the right foot RF) or may change the magnitude of vibration or the vibration period according to the degree of risk or the magnitude of likelihood of departure. When only one foot is placed on the vibrating floor FL, the vibration controller 132 may increase the magnitude of vibration or shorten the vibration period in comparison with a case in which both feet are placed on the floor. Accordingly, it is possible to reliably transmit vibration to the sole even with there being only one foot.

### [Tiptoe Detector]

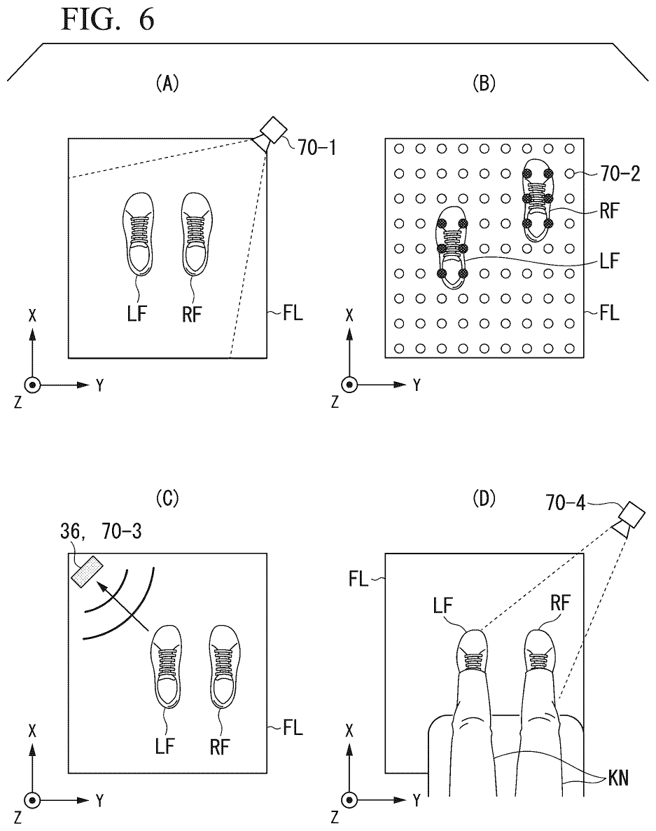

A method of detecting tiptoes of a driver (which include another occupant) in the tiptoe detector 70 will be described below with reference to the drawings. FIG. 6 is a diagram illustrating a tiptoe detection position. In the example illustrated in FIG. 6(A), a camera is used as a tiptoe detector 70-1. This camera is installed at a position at which an area including a position (for example, above the floor FL) at which a driver's foot is placed can be imaged, imaging is performed at predetermined time intervals, and object recognition or the like is performed on the captured camera image using a known image analyzing process to detect the positions of the feet (the left foot LF and the right foot RF).

In the example illustrated in FIG. 6(B), a plurality of pressure-sensitive sensors (pressure sensors) arranged in the floor FL are used as the tiptoe detector 70-2. The pressure-sensitive sensors are arranged in a lattice shape in an area (top surface) of the floor and detect the positions of the tiptoes with positions at which the sensors detect a pressure equal to or greater than a predetermined value as coordinate points. The pressure-sensitive sensors may be installed in a floor mat or may be installed in the floor FL.

In the example illustrated in FIG. 6(C), a vibration meter that measures a magnitude of vibration is used as the tiptoe detector 70-3. The vibration meter is installed, for example, at the installation positions of the vibrators 36. The tiptoe detector 70-3 detects the magnitude of vibration as a feedback from the vibrators 36 and estimates feet positions on the basis of the results of detection. For example, when the vibrators 36 cause the floor FL to vibrate and the positions of the feet (the left foot LF and the right foot RF) are close to the vibrators 36, a load from the feet is applied to the floor FL, and thus the floor FL vibrates less. That is, since vibration measured by the tiptoe detector 70-3 (the vibration meter) is weakened as the feet become closer to the vibrators 36, the tiptoe detector 70-3 detects the positions of the feet on the basis of the measured vibration.

In the example illustrated in FIG. 6(D), a camera is used as the tiptoe detector 70-4. In the example illustrated in FIG. 6(D), an image including knees KN of a driver is captured, and the positions of the tiptoes are estimated from the positions of the knees KN included in the result of analysis of the captured camera image. Accordingly, it is possible to estimate the positions of feet from the positions of the knees KN, for example, even in a situation in which the tiptoes cannot be imaged (for example, a situation in which the driver wears a long skirt or long pants and thus the tiptoes cannot be imaged by the camera).

The tiptoe detector 70 may detect the tiptoes using two or more methods out of the aforementioned detection methods using the tiptoe detectors 70-1 to 70-4. The tiptoe detector 70 may use a radar device instead of (or in addition to) the tiptoe detectors 70-1 to 70-4. In this case, the radar device radiates radio waves such as millimeter waves to the floor FL and detects radio waves (reflected waves) reflected by an object such as a foot to detect a position (a distance and a direction) of the foot. The tiptoe detector 70 may detect that a tiptoe is placed on a pedal operator using the aforementioned method. In this case, it is possible to detect that a tiptoe is placed on the pedal operator by capturing an image including the pedal operator using a camera or installing a pressure-sensitive sensor in the pedal operator.

### <Fourth Vibration Control>

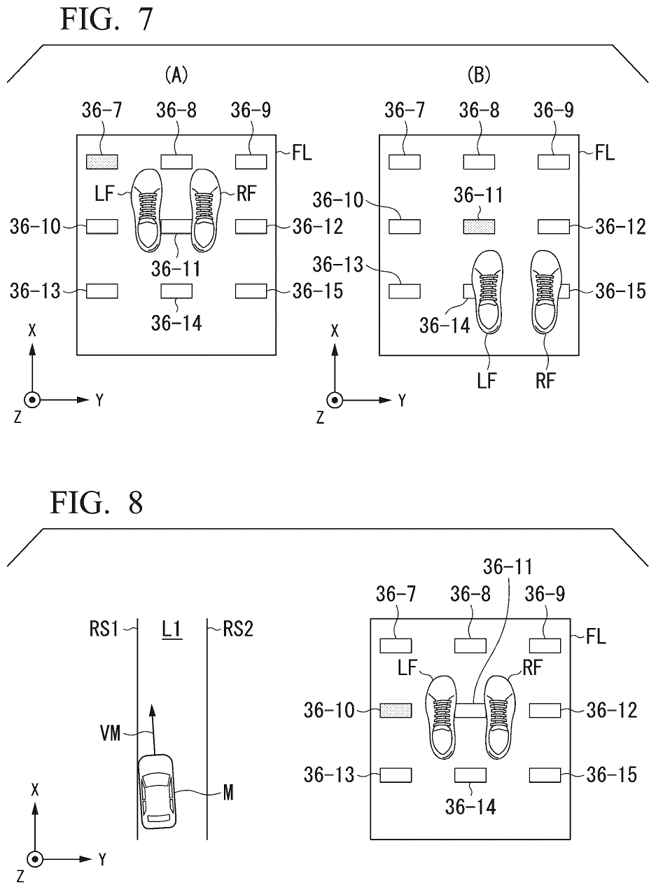

FIG. 7 is a diagram illustrating an example of fourth vibration control. In the fourth vibration control, nine vibrators 36-7 to 36-15 are installed in a lattice shape (3 in longitudinal direction × 3 in lateral direction) on the floor FL as illustrated in FIG. 7. Intervals between the vibrators 36-7 to 36-15 may be equal intervals or may be intervals of different distances therebetween in the lateral direction and in the longitudinal direction. The number or the layout of the vibrators is not limited to the example illustrated in FIG. 6. For example, as illustrated in FIG. 7(A), when both feet (the left foot LF and the right foot RF) are placed slightly in front of (on the front side of) the center of the floor FL and the risk determiner 122 determines that there is a likelihood of contact with an object (an obstacle) on the left-front side of the vehicle M, the vibration controller 132 causes the vibrator 36-7 on the left-front side of the position of the feet to vibrate. At the positions of the feet illustrated in FIG. 7(A), the vibration controller 132 causes the vibrator 36-8 to vibrate when an object determined to have a risk of contact is present in front of the vehicle M and causes the vibrator 36-9 to vibrate when the object is present on the right-front side. The vibration controller 132 causes the vibrator 36-10 to vibrate when it is determined that there is a risk of contact with an object on the left side of the vehicle M and causes the vibrator 36-12 to vibrate when it is determined that there is a risk of contact with an object on the right side of the vehicle M. The vibration controller 132 causes the vibrator 36-13 to vibrate when it is determined that there is a risk of contact with an object on the left-rear side of the vehicle M, causes the vibrator 36-14 to vibrate when it is determined that there is a risk of contact with an object at the back of the vehicle M, and causes the vibrator 36-15 to vibrate when it is determined that there is a risk of contact with an object at the right-rear of the vehicle M.

As illustrated in FIG. 7(B), when both feet are placed on the right-rear side of the floor FL and the risk determiner 122 determines that there is a risk of contact with an object (an obstacle) on the left side in front of the vehicle M, the vibration controller 132 causes the vibrator 36-11 which is located at a position closest to the positions of the feet on the left-front side to vibrate.

Here, it is assumed that vibration is transmitted to feet of both of a driver sitting on a driver's seat and an occupant sitting on a passenger's seat beside the driver's seat, the feet of the driver sitting on the driver's seat are placed at the positions illustrated in FIG. 7(A), and the feet of the occupant sitting on the passenger's seat are placed at the positions illustrated in FIG. 7(B). In this situation, when the risk determiner 122 determines that there is a risk of contact with an object on the left-front side of the vehicle M, the vibration controller 132 causes the vibrator 36-7 in the floor FL of the driver's seat to vibrate and causes the vibrator 36-11 in the floor FL of the passenger's seat to vibrate. Accordingly, it is possible to cause the vibrators to vibrate according to the positions of the feet of each of a plurality of occupants in the vehicle M and to allow each occupant to more accurately ascertain the surrounding conditions.

### <Fifth Vibration Control>

FIG. 8 is a diagram illustrating an example of fifth vibration control. In the fifth vibration control, similarly to FIG. 7, nine vibrators 36-7 to 36-15 (3 in longitudinal direction×3 in lateral direction) are installed in the area of the floor FL. In the fifth vibration control, it is assumed that the traveling situation determiner 124 determines that there is a likelihood that the vehicle M will depart from a lane L1 in a situation in which the vehicle M is traveling at a speed VM in the lane L1 which is defined by left and right marking lines RS1 and RS2. In this case, since there is a likelihood that the vehicle M will depart from the lane to the left, the vibration controller 132 causes the vibrator 36-10 present on the left side with respect to the positions of the feet (the left foot LF and the right foot RF) of the driver to vibrate. The vibration controller 132 may cause the vibrators 36-7, 36-10, and 36-13 on the left side to vibrate in order to easily attract the driver's attention to the left side of the vehicle M. In this case, the vibrators may be caused to vibrate in synchronization or to vibrate sequentially in a predetermined period. Accordingly, it is possible to allow the driver to easily ascertain that there is a likelihood of departure from the marking line RS1 extending on the left side of the vehicle M.

The vibration controller 132 may control the vibration mode according to the magnitude of the likelihood of departure as described above. In this case, for example, the vibration controller 132 increases the magnitude of vibration or shortens the vibration period according to the magnitude of the likelihood of departure.

### <Sixth Vibration Control>

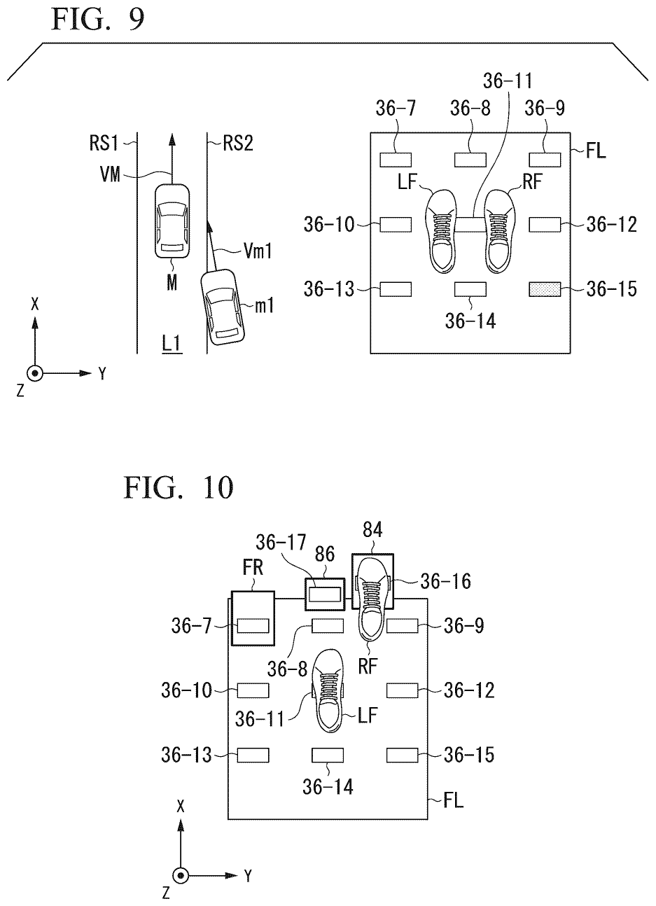

FIG. 9 is a diagram illustrating an example of sixth vibration control. In the example illustrated in FIG. 9, another vehicle ml approaching the vehicle M at a speed Vm 1 from the right-rear side of the vehicle M is illustrated in addition to the vehicle M traveling at a speed VM in a lane L1. The other vehicle ml is an example of an obstacle. In this case, it is assumed that the risk determiner 122 determines that there is a likelihood that the other vehicle ml and the vehicle M will come into contact on the basis of a relative position and a relative speed of the other vehicle ml with respect to the vehicle M. In this case, the vibration controller 132 causes the vibrator 36-15 located on the right-rear side with respect to the left and right feet LF and RF to vibrate.

The vibration controller 132 may perform control such that the magnitude of vibration increases as the degree of risk increases and the likelihood of contact increases. Accordingly, it is possible to more accurately notify an occupant of the magnitude of the likelihood of contact. The vibration controller 132 may change the vibration mode according to a type of an object to come into contact. In this case, the vibration controller 132 changes the vibration mode when the object is another vehicle and when the object is a pedestrian. The vibration controller 132 may cause the vibrators to vibrate in different vibration modes when it is determined that there is a risk of contact with an object and when there is a likelihood of departure from a lane (a marking line). Accordingly, it is possible to allow the driver (the occupant) to ascertain more detailed surrounding conditions according to a difference in vibration mode.

### <Seventh Vibration Control>

FIG. 10 is a diagram illustrating an example of seventh vibration control. In the seventh vibration control, when a vibrator is provided in each pedal operator (the accelerator pedal 84 and the brake pedal 86) and a footrest, vibration control using these vibrators 36 together is performed. In the example illustrated in FIG. 10, a footrest FR is provided on the left-upper side of the floor FL, and a vibrator 36-7 is installed therein. In the other area of the floor FL, vibrators 36-8 to 36-15 are provided in a lattice shape. In the example illustrated in FIG. 10, a vibrator 36-16 is provided in the accelerator pedal 84, and a vibrator 36-17 is provided in the brake pedal 86. A plurality of vibrators may be provided in each of the footrest FR, the accelerator pedal 84, and the brake pedal 86. In the example illustrated in FIG. 10, the driver's left foot LF is placed at the center of the floor FL, and the right foot RF is placed on the accelerator pedal 84. The tiptoe detector 70 detects the positions of the left and right tiptoes of the driver. In the embodiment, the AP sensor 84A may detect a foot placed on the accelerator pedal 84, and the BP sensor 86A may detect a foot placed on the brake pedal 86.

In the seventh vibration control, when the risk determiner 122 determines that there is a risk of contact with an object and/or when the traveling situation determiner 124 determines that there is a likelihood that the vehicle M will depart from a traveling lane (a marking line) and when one foot is placed on the pedal operator, a vibrator closest to the foot is caused to vibrate. In the example illustrated in FIG. 10, the vibration controller 132 causes the vibrators 36-11 and 36-16 to vibrate.

As described in the seventh vibration control, by providing a vibrator in the pedal operator, it is possible to provide a tactile stimulus to a driver via the pedal and to reliably cause the driver to receive notification based on vibration even when the driver's foot moves from the floor to the pedal operator.

The vibration controller 132 may cause a vibrator in a direction in which there is a risk or in a direction in which there is a likelihood of lane departure to vibrate when the feet are placed on the floor FL. Accordingly, it is possible to notify the driver of information on the direction.

When a driving mode of the vehicle M is a manual driving mode or is switched from an automated driving mode to the manual driving mode on the basis of the control state in the traveling controller 136, the vibration controller 132 may perform control such that the vibrators 36-16 and 36-17 provided in the pedal operators vibrate on the basis of the results of determination from the determiner 120. Accordingly, it is possible to cause the vibrator provided in the pedals to vibrate in a state in which the driver is more likely to operate the pedals.

In the seventh vibration control, when a foot is placed on the footrest FR, the vibration controller 132 causes the vibrator 36-7 provided in the footrest FR to vibrate on the basis of the results of determination from the determiner 120.

In the embodiment, each of the first to sixth vibration control may be combined with at least a part of other vibration control.

### [Installation Example of Vibrators 36]

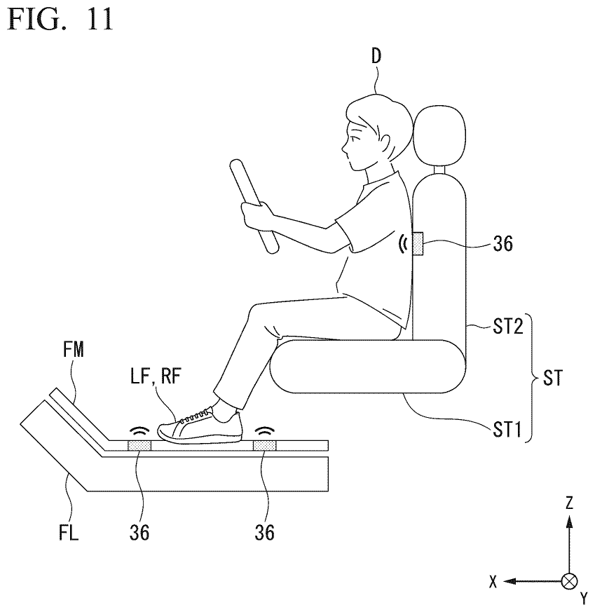

An installation example of the vibrators 36 according to the embodiment will be described below with reference to the drawings. FIG. 11 is a diagram illustrating a first installation example of the vibrators 36. In the example illustrated in FIG. 11, a positional relationship between the floor FL and the seat ST in the vicinity of the driver's seat is schematically illustrated when seen in the lateral direction. In the example illustrated in FIG. 11, a vibrator 36 is provided in the back seat portion ST2, and a plurality of vibrators 36 are arranged at predetermined intervals in a floor mat FM spread on the floor FL. The pressure-sensitive sensor (the tiptoe detector 70-2) may be installed in the floor mat FM. By providing the vibrators 36 in the floor mat FM, it is possible to transmit vibration with a higher resolution to the feet of the driver D. Since the vibrators 36 do not need to be newly installed in the floor FL, it is possible to reduce cost or to reduce a burden of installation work.

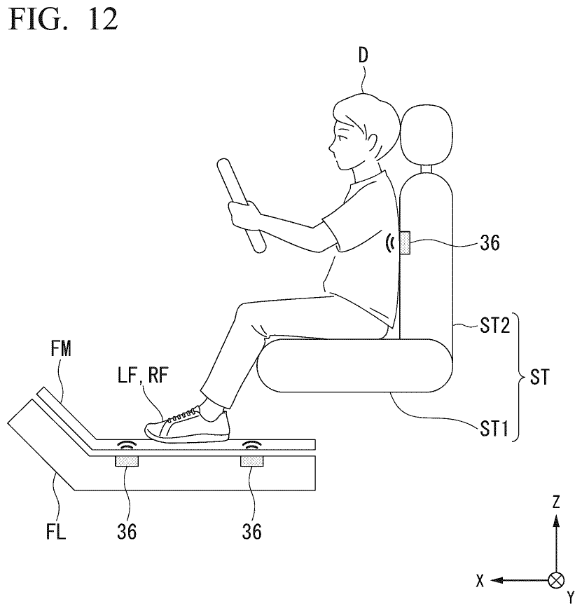

The vibrators 36 may be installed in the floor FL such that vibration propagates satisfactorily in consideration of a material of the floor mat FM. FIG. 12 is a diagram illustrating a second installation example of the vibrators 36. In the second installation example, a plurality of vibrators 36 are provided in the floor FL in comparison with the first installation example. Accordingly, it is possible to cause a vibrator at an appropriate position to vibrate even when the position of the floor mat FM is offset.

In the first and second installation examples, a general floor mat FM is formed of a material having damping or sound absorbing characteristics for the purpose of reduction in vibration (road noise) when the vehicle Mis traveling. Accordingly, when the vibrators 36 are installed in the floor FL, a vibration transmission method needs to be studied such that vibration does not damp. As a result, for example, when the vibrators are installed in the floor mat FM as in the first installation example, a first layer (a lower layer) which is in contact with the floor FL in a stacked structure of the floor mat FM is formed as a damping and sound absorbing layer, the vibrators 36 are installed in a second layer (an intermediate layer), and a third layer (an upper layer) is formed as a surface layer. Accordingly, it is possible to easily transmit vibration from the vibrators 36 to the soles. In the second installation example, by providing a material having damping or sound absorbing characteristics below (on the ground side) of the floor FL and installing the vibrators thereon, that is, by employing a configuration in which the floor mat FM does not include a surface layer or a damping or sound absorbing layer, it is possible to easily transmit vibration from the vibrators 36 to the soles.

### [Notification Control]

In the embodiment, when the vibration controller 132 causes the vibrators 36 to vibrate, the notification controller 134 may generate an image or speech representing a reason of vibration and output the image or sound from the HMI 30. Accordingly, it is possible to allow an occupant to ascertain what reason vibration to the feet is based on.

The notification controller 134 may control a notification timing of information by display or speech output with the HMI 30 and a vibration timing of the vibrators 36 by the vibration controller 132 synchronously under predetermined conditions or stepwise. For example, vibration control in the vibration controller 132 is performed when the degree of risk determined by the risk determiner 122 is less than a first threshold value, vibration control in the vibration controller 132 and alarm output (alarm display and speech output) in the notification controller 134 are performed when the degree of risk is equal to or greater than the first threshold value. In this way, by performing notification using image display or speech output together according to the degree of risk, it is possible to allow the driver to adopt behavior corresponding to the risk.

The notification controller 134 may change colors or luminance of an image or change speech according to the degree of risk. In this case, the notification controller 134 linearly or stepwise increases a notification intensity (for example, luminance and sound volume) as the degree of risk changes from a low step to a high step. Alternatively, vibration and display output (speech output) are simultaneously provided regardless of the degree of risk. By performing notification in combination of a plurality of senses such as a tactile sense, a visual sense, and an auditory sense in this way, it is possible to achieve a multimodal effect and to further improve intuition.

Control in which the notification control in the notification controller 134 and the vibration control in the vibration controller 132 are combined may be applied when the traveling situation determiner 124 determines that the vehicle M will depart from a lane. In this case, the notification control and the vibration control are synchronously performed or stepwise control is performed according to the magnitude of a likelihood of departure or the like.

### [Notification of Shoes]

When it is determined that a driver wears shoes instead of footwear suitable for driving on the basis of a type of the driver's footwear recognized by the shoe recognizer 114, the notification controller 134 may notify the driver of information using at least one of display and speech via the HMI 30.

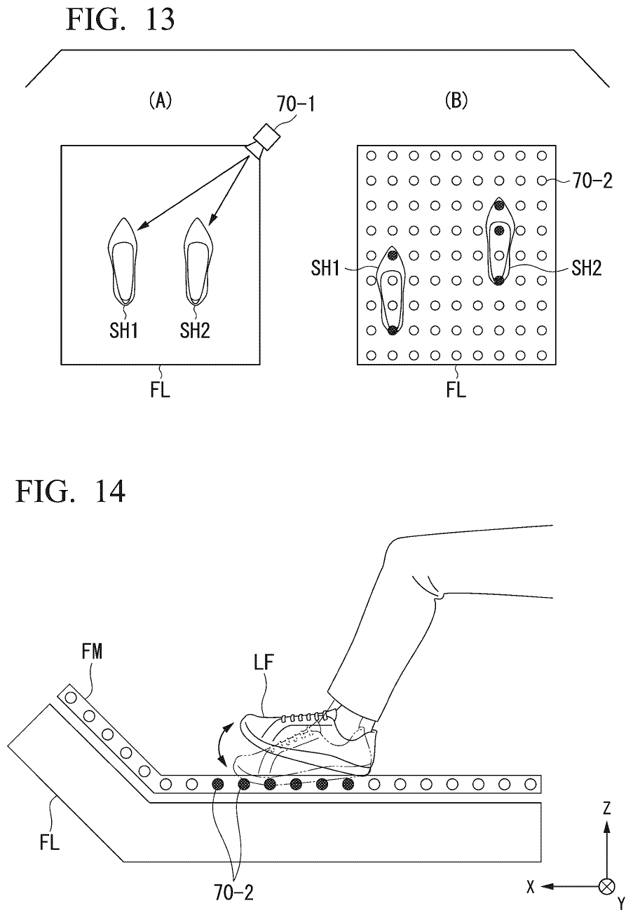

FIG. 13 is a diagram illustrating an example of detection of shoes. FIG. 13(A) illustrates an example in which the tiptoe detector 70-1 is a camera, and FIG. 13(B) illustrates an example in which the tiptoe detector 70-2 includes a pressure-sensitive sensor arranged in a lattice shape on the floor FL.

For example, the shoe recognizer 114 recognizes a type of shoes on the basis of a result of analysis of a camera image from the tiptoe detector 70-1 illustrated in FIG. 13(A). Regarding the type of shoes, for example, a type of shoes with a higher matching value can be detected by performing a pattern matching process between feature information such as a shape, a size, and a color of an object acquired from the result of analysis and feature information correlated with predetermined types of shoes.

The shoe recognizer 114 estimates a type of shoes from a sensor output range of the pressure-sensitive sensors arranged in the lattice shape in the tiptoe detector 70-2 as illustrated in FIG. 13(B). Some shoes are less likely to transmit vibration of the vibrators 36, and thus the notification controller 134 notifies the driver of a disclaimer, notifies that a notification function based on vibration is invalid, or notifies that replacement with appropriate shoes is necessary by performing image display, speech output, or the like via the display 32, the speaker 34, or the like when the footwear of the driver is shoes not suitable for driving or shoes (for example, high heels or thick-soled shoes) which are less likely to transmit vibration. Accordingly, it is possible to attract the driver's attention to safe driving.

### [Starting or Stopping of Vibration Control in Motion Recognizer 116]

Starting or stopping control of vibration control in the motion recognizer 116 will be specifically described below. FIG. 14 is a diagram illustrating recognition of an occupant's foot motion that is performed by the motion recognizer 116. In the example illustrated in FIG. 14, pressure-sensitive sensors are installed as the tiptoe detector 70-2 in the floor mat FM spread on the floor FL. The motion recognizer 116 recognizes that a predetermined motion has been performed when it is detected that the occupant has tapped the floor mat FM with the feet (tiptoes or heels) predetermined times in a predetermined time on the basis of results of detection from the pressure-sensitive sensors.

When a camera is used as the tiptoe detector 70-1, the motion recognizer 116 analyzes a camera image to detect a motion of the occupant's tiptoe and recognizes that a predetermined motion has been performed, for example, when a motion of the tiptoe shaking laterally two or more times has been detected.

When the motion recognizer 116 recognizes that the occupant has performed the predetermined motion, the vibration controller 132 controls starting or stopping of the vibration control for the occupant (vibration control with the vibrators installed in the floor FL below a seat on which the occupant is sitting). For example, the vibration control ends when the vibration control has started and starts the vibration control when the vibration control has ended.

Accordingly, when an occupant feels troublesome from the notification based on vibration due to the surrounding conditions, the occupant's mental state, or the like, it is possible to arbitrarily stop the vibration control through the occupant's intuitive operation or to restart the stopped vibration control. Switching between starting and stopping of the vibration control may be controlled on the basis of an operation on a switch provided in the HMI 30 instead of a result of recognition of the occupant's foot motion.

### [Modified Examples]

In the embodiment, when the vehicle M is traveling on a road giving vibration (an off road), the vibration controller 132 may stop the vibration control. In this case, the vehicle M may determine whether the traveling road is an off road such as a mountain path with reference to the map information 54 on the basis of the position information of the vehicle M or may determine whether the traveling road is an off road on the basis of the results of detection from the vibration sensors included in the vehicle sensor 40. Accordingly, it is possible to curb vibration at the time of traveling of the vehicle M (road noise) and vibration based on the vibrators 36 giving discomfort to the occupant without being mixed.

In the embodiment, the vibration controller 132 may register a position at which the feet are placed in advance for each occupant or may statistically acquire a position of the feet and determine the positions of a vibrator 36 to vibrate out of a plurality of vibrators 36 to correspond to the occupant with respect to the acquired position. Accordingly, it is possible to reduce a process load for detecting the foot position. The vibration controller 132 may register a vibration mode in advance for each occupant and control the vibration mode of the vibrators 36 for each occupant on the basis of the registered information. Accordingly, it is possible to notify an occupant using the occupant's favorite vibration.

### [Process Flow]

An example of a process flow that is performed by the driving support device 100 according to the embodiment will be described below with reference to a flowchart. In the following example, a vibration control process out of processes performed by the driving support device 100 will be mainly described. The following process flow may be performed repeatedly in a predetermined period or at a predetermined timing.

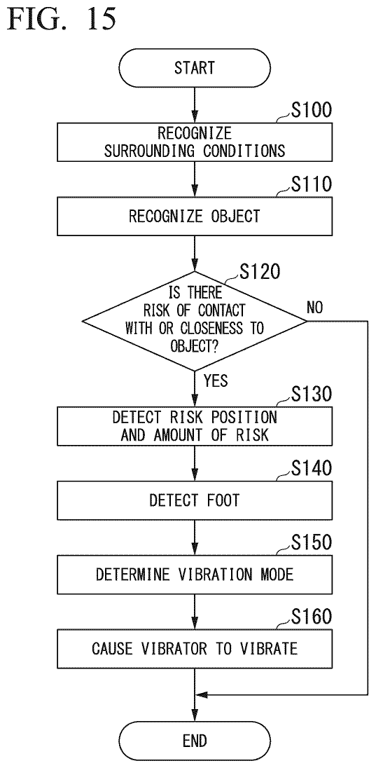

FIG. 15 is a flowchart illustrating an example of a process flow that is performed by the driving support device 100 according to the embodiment. In the example illustrated in FIG. 15, the surrounding condition recognizer 112 recognizes the surrounding conditions of a vehicle M (Step S100). Then, the surrounding condition recognizer 112 recognizes an object (for example, an obstacle) near the vehicle M (Step S110). Then, the risk determiner 122 determines whether there is a risk of contact or closeness between the vehicle M and the object on the basis of a relative position, a relative speed, or the like of the object with respect to the vehicle M (Step S120). When it is determined that there is a risk of contact or closeness, the risk determiner 122 detects a risk position relative to the vehicle M and a magnitude of risk (Step S130). In the process of Step S130, a risk direction in which the risk has occurred may be detected instead of (or in addition to) the risk position or the magnitude of risk. Then, the tiptoe detector 70 detects a driver's foot (Step S140). Then, the vibration controller 132 determines a vibration mode for the vibrator 36 (for example, a position of a vibrator to vibrate, a magnitude of vibration, and a vibration period) based on the risk position, the magnitude of risk, the degree of risk, and the like (Step S150). The target vibrator 36 is caused to vibrate on the basis of the determined vibration mode. Accordingly, the process flow of the flowchart ends. When it is determined in the process of Step S120 that there is no risk of contact or closeness between the vehicle M and the object, the process flow of the flowchart ends.

In the processes of Steps S120 to S130 illustrated in FIG. 15, a process of causing the traveling situation determiner 124 to determine whether the vehicle M will depart from a lane on the basis of a distance or a speed VM between the vehicle M and a marking line, a moving direction, and the like (Step S120) and detecting a direction of departure when it is determined that the vehicle M will depart (Step S130) may be performed instead of (or in addition to) the processes.

As described above, the driving support device according to the embodiment includes the surrounding condition recognizer 112 configured to recognize the surrounding conditions of a vehicle M, a plurality of vibrators 36 configured to provide a stimulus based on vibration to an occupant of the vehicle M, and the vibration controller 132 configured to cause at least one vibrator out of the plurality of vibrators 36 to vibrate on the basis of a relative position of the vehicle M with respect to an object recognized by the surrounding condition recognizer 112 and a direction of the object with respect to the vehicle M, and at least one of the plurality of vibrators 36 is installed at a position at which vibration is able to be provided to a sole of the occupant of the vehicle M. Accordingly, it is possible to contribute to development of a sustainable transportation system.

For example, according to the embodiment, it is possible to realize object notification with which a target position can be intuitively understood by an occupant in the vehicle by causing the floor to vibrate. For example, by directly providing a tactile stimulus based on vibration to a driver's foot or the like, the driver can intuitively recognize a position and a moving direction of an obstacle, thus rapidly perform a preliminary action for collision avoidance (for example, shortening of a search time consumed in recognition thanks to improvement in intuition) in a potentially risky situation, and recognize a risk without seeing the display through notification using a tactile stimulus. Accordingly, it is possible to reduce a load of the driver.

According to the embodiment, since the vibrators are appropriately selected or a magnitude of vibration (a vibration intensity) or a vibration period, for example, according to a driving situation (more specifically, a distance to a target objet, a first time to collision TTC, or the like) such as a degree of risk or a risk direction, it is possible to allow an occupant to more intuitively ascertain the risk. According to the embodiment, since a position at which a tiptoe is located on the floor is recognized using a camera, or a coordinate position is calculated from an output signals of the pressure-sensitive sensors laid out in a lattice shape to identify the position and the vibrators are controlled according to the identified position of the tiptoe, it is possible to realize more appropriate transmission of vibration.

According to the embodiment, by demanding replacement of shoes to a drive wearing shoes which vibration is not transmitted well and which have a structure not suitable for driving or notifying the driver that the function is invalidated, it is possible to secure attraction of the driver's attention to safe driving and reliability of the function. According to the embodiment, since turning-on and turning-off of vibration control are controlled according to a tapping motion or a gesture motion on the floor, it is possible to enhance convenience.

The above-mentioned embodiment can be expressed as follows:

A driving support device comprising:
a storage medium configured to store computer-readable instructions; and
a processor connected to the storage medium,
wherein the processor executes the computer-readable instructions to perform:
   recognizing surrounding conditions of a vehicle; and
   causing at least one vibrator out of a plurality of vibrators, which are configured to provide a stimulus based on vibration to an occupant of the vehicle, to vibrate on the basis of a relative position of the vehicle with respect to an object included in the recognized surrounding conditions and a direction of the object with respect to the vehicle,
wherein at least one of the plurality of vibrators is installed at a position at which vibration is able to be provided to a sole of the occupant of the vehicle.

While an embodiment of the present invention has been described above, the present invention is not limited to the embodiment and can be further subjected to various modifications and substitutions without departing from the gist of the present invention.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A driving support device comprising:
a surrounding condition recognizer configured to recognize surrounding conditions of a vehicle;
a plurality of vibrators configured to provide a stimulus based on vibration to an occupant of the vehicle; and
a vibration controller configured to cause at least one vibrator out of the plurality of vibrators to vibrate on the basis of a relative position of the vehicle with respect to an object recognized by the surrounding condition recognizer and a direction of the object with respect to the vehicle,
wherein at least one of the plurality of vibrators is installed at a position at which vibration is able to be provided to a sole of the occupant of the vehicle.

2. The driving support device according to claim 1, wherein the vibration controller determines a vibration mode in the plurality of vibrators according to the relative position and the direction of the object.

3. The driving support device according to claim 1, further comprising a tiptoe detector configured to detect a position of a tiptoe of the occupant,
wherein the vibration controller determines a vibration mode in the plurality of vibrators according to the position of the tiptoe detected by the tiptoe detector.

4. The driving support device according to claim 3, further comprising a notifier configured to notify the occupant of information using at least one of display and sound,
wherein the occupant includes a driver of the vehicle,
wherein the tiptoe detector detects a shoe of the driver, and
wherein the driving support device further comprises a notification controller configured to notify the driver via the notifier when the shoe of the driver is a shoe which is not suitable for driving.

5. The driving support device according to claim 1, further comprising a motion recognizer configured to recognize a predetermined motion of the occupant's foot,
wherein the vibration controller controls starting or stopping of vibration control of the vibrators according to a predetermined tapping motion or a predetermined gesture motion of the occupant's foot recognized by the motion recognizer.

6. The driving support device according to claim 4, wherein the notification controller performs notification of the occupant via the notifier on the basis of a degree of risk of contact or closeness between the vehicle and the object, and
wherein a notification timing in the notification controller and a vibration timing in the vibration controller are controlled synchronously or stepwise under predetermined conditions.

7. The driving support device according to claim 1, wherein at least one of the plurality of vibrators is installed in a pedal operator of the vehicle, and
wherein the vibration controller performs vibration control on the vibrator installed in the pedal operator when a driving mode of the vehicle is a manual driving mode or when the driving mode is switched from an automated driving mode to the manual driving mode.

8. The driving support device according to claim 1, wherein at least one of the plurality of vibrators is installed in a pedal operator of the vehicle, and
wherein the vibration controller performs vibration control on the vibrator installed in the pedal operator when a foot of a driver of the vehicle comes into contact with the pedal operator.

9. A driving support method that is performed by a computer, the driving support method comprising:
recognizing surrounding conditions of a vehicle; and
causing at least one vibrator out of a plurality of vibrators, which are configured to provide a stimulus based on vibration to an occupant of the vehicle, to vibrate on the basis of a relative position of the vehicle with respect to an object included in the recognized surrounding conditions and a direction of the object with respect to the vehicle,
wherein at least one of the plurality of vibrators is installed at a position at which vibration is able to be provided to a sole of the occupant of the vehicle.

10. A non-transitory computer-readable storage medium for storing a program causing a computer to perform:
recognizing surrounding conditions of a vehicle; and
causing at least one vibrator out of a plurality of vibrators, which are configured to provide a stimulus based on vibration to an occupant of the vehicle, to vibrate on the basis of a relative position of the vehicle with respect to an object included in the recognized surrounding conditions and a direction of the object with respect to the vehicle,
wherein at least one of the plurality of vibrators is installed at a position at which vibration is able to be provided to a sole of the occupant of the vehicle.
